(19) United States
(12) Patent Application Publication
(10) Pub. No.: US 2025/0103313 A1
(43) Pub. Date: Mar. 27, 2025

(54) VEHICLE INFORMATION PROCESSING DEVICE

(71) Applicant: TOYOTA JIDOSHA KABUSHIKI KAISHA, Toyota-shi (JP)

(72) Inventors: Satofumi KURISU, Nagoya-shi (JP); Kosuke Ohashi, Kiyosu-shi (JP); Ryo Anan, Toyota-shi (JP); Ryota Nakabayashi, Nagoya-shi (JP); Nobutaka Suzuki, Toyota-shi (JP); Kiyoto Suzuki, Tokoname-shi (JP)

(73) Assignee: TOYOTA JIDOSHA KABUSHIKI KAISHA, Toyota-shi (JP)

(21) Appl. No.: 18/749,850

(22) Filed: Jun. 21, 2024

(30) Foreign Application Priority Data
Sep. 26, 2023 (JP) 2023-163692

(51) Int. Cl. G06F 8/61; G06F 11/30

(52) U.S. Cl. CPC G06F 8/61; G06F 11/3034

(57) ABSTRACT

When a request for storing a new application is received in the first storage unit, a new application is downloaded and the new application is stored in the first storage unit, a maximum usage amount of the second storage unit used in association with the execution of the new application is calculated, and when the calculated maximum usage amount is larger than the set value, the new application is erased from the first storage unit, and when the calculated maximum usage amount is equal to or smaller than the set value, the new application is put into an executable state without being erased from the first storage unit.

### CROSS-REFERENCE TO RELATED APPLICATION

This application claims priority to Japanese Patent Application No. 2023-163692 filed on Sep. 26, 2023, incorporated herein by reference in its entirety.

### BACKGROUND

### 1. Technical Field

The present disclosure relates to a vehicle information processing device.

### 2. Description of Related Art

Japanese Unexamined Patent Application Publication No. 2012-185704 (JP 2012-185704 A) discloses an information processing device that stores a plurality of applications. The information processing device can execute the applications concurrently. When the applications are executed concurrently, the information processing device monitors a memory usage amount associated with execution of each of the applications.

### SUMMARY

In a technology such as JP 2012-185704 A, it is occasionally requested to add a new application to the information processing device. It is assumed, at this time, that the new application is added to the information processing device without considering the specifications required for the information processing device in order to execute the application. In this case, there is a possibility that execution of each application is hindered after the new application is added.

In order to address the above issue, an aspect provides a vehicle information processing device including: an execution unit; a first storage unit that stores an application that is executable by the execution unit; and a second storage unit that temporarily stores data generated by the execution unit executing the application, in which the execution unit is configured to: when a request to store a new application in the first storage unit is received, download the new application and store the new application in the first storage unit; calculate a maximum usage amount of the second storage unit to be used in conjunction with execution of the new application; and erase the new application from the first storage unit when the calculated maximum usage amount is more than a set value determined in advance, and render the new application executable without erasing the new application from the first storage unit when the calculated maximum usage amount is equal to or less than the set value.

According to the above technical idea, it is possible to suppress execution of each application being hindered when a new application is added and the new application is executed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is a flow chart showing a process sequence of the addition process; and

FIG. 3 is a flowchart illustrating a processing procedure of the stop processing.

### DETAILED DESCRIPTION OF EMBODIMENTS

Hereinafter, an embodiment of a vehicle information processing device will be described with reference to the drawings. In the present embodiment, a vehicle information processing device is applied to a battery electric vehicle.

### Overall Configuration of Vehicle

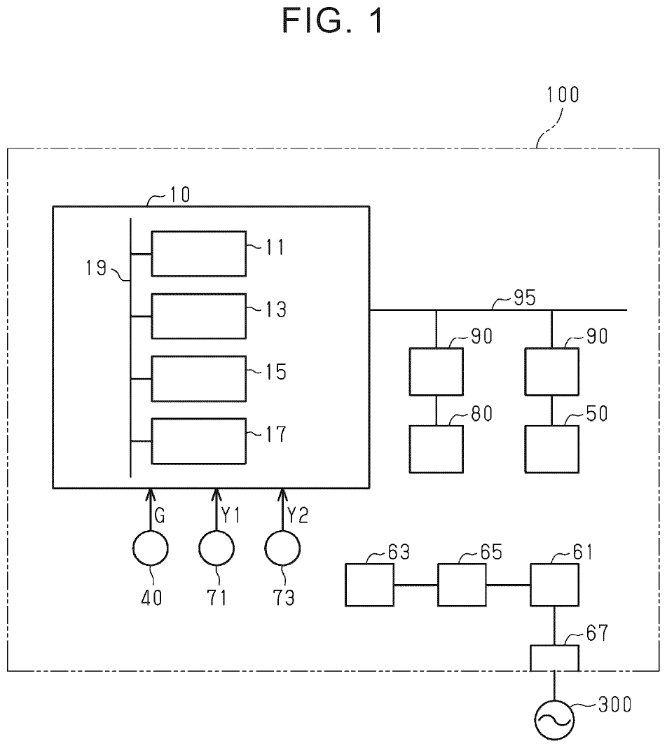

As illustrated in FIG. 1, the vehicle 100 includes an information processing device 10. The information processing device 10 includes a CPU11, a storage 13, a RAM15, and a communication module 17. CPU11 constitutes an execution unit. The storage 13 is an electrically rewritable nonvolatile memory. The storage 13 constitutes a first storage unit. RAM15 are volatile memories. RAM15 constitutes a second storage unit. The communication module 17 is a communication circuit for wirelessly communicating with the outside via an external communication network. CPU11, the storage 13, RAM15 and the communication module 17 can communicate with each other via the internal bus 19.

The vehicle 100 includes a plurality of specific control devices 90. In FIG. 1, two of the plurality of specific control devices 90 are represented. Each specific control device 90 is an electronic control device that controls a specific one of the plurality of in-vehicle devices. One of the plurality of in-vehicle devices is a motor 50 for traveling of the vehicle 100. One of the plurality of in-vehicle devices is a display 80 described later. In addition, examples of the in-vehicle device include a brake device, an air conditioner, a meter display device, and a converter 65 to be described later. Each specific control device 90 is capable of communicating with the information processing device 10 via an external bus 95.

The vehicle 100 includes a display 80. The display 80 is located in the vehicle cabin. The display 80 is controlled by the specific control device 90 that receives a command signal from the information processing device 10. The display 80 can display various types of information. Note that, as described above, the specific control device 90 is interposed between the display 80 and the information processing device 10, and a description of this point is omitted. That is, it may be described as if the display 80 and the information processing device 10 directly transmit and receive information. The display 80 is a so-called touch panel type. That is, the display 80 also functions as an input device that receives an input of information from the outside. The display 80 transmits information input from the outside to the information processing device 10.

The vehicle 100 includes a power supply system. The power supply system includes a drive battery 61, an auxiliary battery 63, a converter 65, a connector 67, a first battery sensor 71, and a second battery sensor 73.

The connector 67 is connectable to an external power source 300 of the vehicle 100. The drive battery 61 is a secondary battery. The drive battery 61 is a high-voltage battery for traveling by the vehicle 100. The drive battery 61 is connected to the connector 67. The drive battery 61 receives power supply from the external power source 300 via the connector 67. The drive battery 61 supplies electric power to the motor 50 for traveling.

The auxiliary battery 63 is a secondary battery. The auxiliary battery 63 is a low-voltage battery having a rated voltage lower than that of the drive battery 61. The auxiliary battery 63 is connected to the drive battery 61 via a converter 65. The auxiliary battery 63 supplies electric power to auxiliary equipment of the vehicle 100. The auxiliary equipment of the vehicle 100 includes an information processing device 10, each specific control device 90, a display 80, various switches, various sensors, and the like.

The converter 65 lowers the output voltage from the drive battery 61 and outputs the voltage to the auxiliary battery 63. The converter 65 boosts the output voltage from the auxiliary battery 63 and outputs the boosted output voltage to the drive battery 61.

The first battery sensor 71 detects the first battery information Y1 such as the temperature/voltage/current of the drive battery 61 at a predetermined control cycle. Each time the first battery information Y1 is detected, the first battery sensor 71 outputs the first battery information Y1 detected by itself to the information processing device 10.

The second battery sensor 73 detects the second battery information Y2 such as the temperature, the voltage, and the current of the auxiliary battery 63 at a predetermined control cycle. Each time the second battery information Y2 is detected, the second battery sensor 73 outputs the second battery information Y2 detected by itself to the information processing device 10.

The vehicle 100 includes a start switch 40. The start switch 40 is a switch for the user to instruct activation of the vehicle 100. The start switch 40 outputs a signal G corresponding to the user's on/off operation to the information processing device 10.

### Details of Information Processing Device

The storage 13 stores in advance a plurality of applications and various kinds of data necessary for execution of each application. The application is, for example, various programs for controlling and managing various parts of the vehicle 100. Each application stored in the storage 13 is in a state in which activation described later is completed. CPU11 can execute the applications stored in the storage 13. RAM15 temporarily stores data generated as CPU11 executes the application. CPU11 executes the respective applications as needed. CPU11 may execute a plurality of applications in parallel. When the application is executed, CPU11 outputs a command signal to the specific control devices 90 to realize various processes required.

Various types of supplementary information are attached to the application. The supplementary information means that supplementary information that is not directly involved in the execution of the program is described in addition to the main source code that is essential in the execution of the program. An example of the supplementary information is an application identification value assigned to each application. Another example of the ancillary information is the priority level of each application. The additional information such as the application identification value and the priority level is attached to the application in advance before the application is mounted on the vehicle 100. Note that, as will be described later in the additional process, CPU11 may add additional information to the application stored in the storage 13.

The priority level is a level indicating a priority level of continuing execution of the application when CPU11 executes the application. The higher the priority level, the higher the priority for continuing execution of the application. In the present embodiment, three priority levels are set. The application of level 3, which is the highest priority level, is an application that is responsible for controlling the travel of the vehicle 100, for example, by causing the vehicle 100 to autonomously drive. The level 2 application, which is an intermediate level, is an application that provides information on the traveling to the user, for example, by causing the navigation system to function. The level 1 application, which is the lowest priority level, is an application other than the level 2 and level 3 applications, e.g., providing entertainment information to the user.

### Additional Processing

CPU11 can perform an additional process. The addition process is a process for adding a new application to the storage 13. As will be described later, CPU11 suspends the execution of all the pre-existing applications while the additional process is being executed. Therefore, the vehicle 100 cannot be controlled through the execution of the application during the execution of the additional processing. In connection with this, when CPU11 receives a message indicating that it is desired to add a new application from the user through the display 80, it displays on the display 80 that all the existing applications cannot be executed while the addition process is being executed. In response to the user's permission operation on the display, the display 80 transmits an installation request signal. The installation request signal is a signal for requesting the storage 13 to store a new application. When CPU11 receives an install request from the display 80, it starts the addition process.

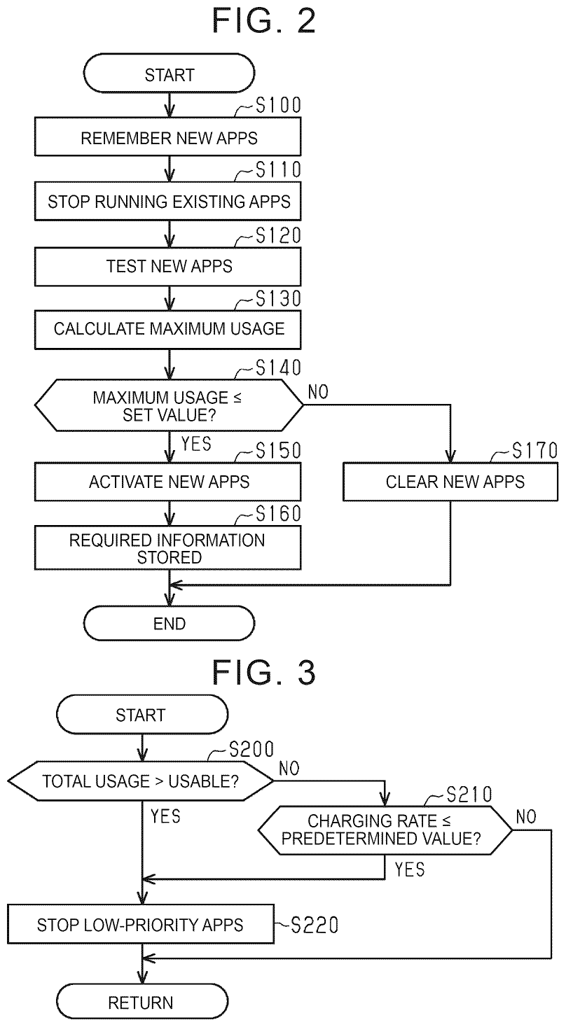

As illustrated in FIG. 2, when CPU11 starts the addition process, it first executes S100 process. In S100, CPU11 downloads a new application and stores the downloaded new application in the storage 13. After that, CPU11 advances the process to S110. Note that at the time of completion of S100 process, the new application has not yet been activated. Here, “activation” means that the application is in an executable state. However, even in a state where the application is not activated, it is possible to execute the application virtually without the operation of the in-vehicle device. Executing an application under virtual conditions in this way is referred to as test execution in the following.

In S110, CPU11 suspends the execution of all the pre-existing applications except the application for executing the additional process. The present application is an application stored in the storage 13 at the time when CPU11 receives an install request. Existing applications can be said to be currently enabled applications. With respect to S110 process, CPU11 maintains the state as it is for a pre-existing application that is in a non-running state at the time the process proceeds to S100. When CPU11 finishes executing S110 process, it advances the process to S120.

In S120, CPU11 performs testing of the new application. In testing, CPU11 executes the new application for a predetermined period of time and monitors the usage of RAM15 during the execution of the new application. The manner in which a new application is executed in the test execution is the same as that in the case of executing the application at normal time. However, the point where RAM15 usage is monitored and the point where it is virtually executed differ from the normal execution status. Monitoring the usage of RAM15 is specifically to repeatedly acquire the usage of RAM15 at the respective timings associated with executing the new application. In testing, CPU11 acquires the usage of RAM15 and then stores the usage of the acquired RAM15 in RAM15 over time. Hereinafter, the time series of the usage amounts of RAM15 acquired in the test execution will be referred to as a test time series.

Incidentally, when the execution of an application is continued, the usage of RAM15 used in association with the execution of the application increases or decreases. In order to be able to capture the maxima of RAM15 usage that can occur in such an increase or decrease, the above-mentioned predetermined times are defined. Specifically, the predetermined time is determined in advance by experimentation or the like as a length of time enough to capture a series of variation processes of the usage of RAM15 when the application is executed. The series of varying processes of RAM15 usage includes the maxima and minima of RAM15 usage that are used in conjunction with executing the application. When CPU11 finishes the testing, the process proceeds to S130.

In S130, CPU11 calculates the maximal usage of RAM15 used in conjunction with executing the new application. Specifically, CPU11 refers to the testing time series obtained in S120. CPU11 then identifies the maximum in the test-time series as the maximum usage. After that, CPU11 advances the process to S140.

In S140, CPU11 determines whether or not the maximal usage calculated by S130 is equal to or less than a set point. As a concrete process of S140, CPU11 first calculates the maximum total usage as a premise of the setting. The maximum total usage amount is the usage amount of RAM15 that is used in association with the execution of all the pre-existing applications in parallel. CPU11 calculates the maximum total usage by referring to the usage list stored in the storage 13. The maximal usage of RAM15 used to run an application is referred to as the application usage. The usage amount list is a list in which a first data set in which one application and an application usage amount corresponding to the application are associated with each other is arranged by all existing applications. In other words, the usage amount list describes the application usage amount for each existing application for each of all existing applications. For example, in the usage list, an existing application is represented by an application identification value. The usage amount list currently stored in the storage 13 is obtained by adding the first data set every time a new application is added to the initial data of the usage amount list. The initial data of the usage amount list is stored in the storage 13 at the time of factory shipment of the vehicle 100. CPU11 refers to the usage list and calculates the sum of all the application usage amounts in the usage list as the maximum total usage amount. When CPU11 calculates the maximum total usage, it calculates the set point. The set value is determined in advance as a value obtained by subtracting the maximum total usage amount from the usable amount. The usable amount is determined in advance as a value that is slightly smaller than the largest storage capacity that can use RAM15 without causing the storage area of RAM15 to be tightened. The storage 13 stores the usable amount in advance. When CPU11 calculates the set value, it compares the maximal usage calculated by S130 with the set value. Then, CPU11 advances the process to S170 if the maximal usage is greater than the set value (S140: NO).

In S170, CPU11 erases the new application from the storage 13. For example, CPU11 completely erases the new application from the storage 13. With regard to S170 process, CPU11 may be configured not to completely erase a new application but to treat a memory cell group in which a new application is written as an overwritable free area. That is, erasing a new application from the storage 13 in the present S170 is not limited to completely erasing a new application. When CPU11 finishes executing S170 process, it finishes the series of processes of the addition process. At this time, CPU11 may notify the user through the display 80 that the addition of a new application to the storage 13 is not possible at present.

On the other hand, in S140, CPU11 advances the process to S150 when the maximal usage is equal to or less than the set value (S140: YES). In S150, CPU11 activates a new application. This activation process allows the new application to be ready for execution. The validation of the present embodiment is to attach a validation flag as supplementary information to a new application. The activation flag indicates that the application is approved to be added to the storage 13, and CPU11 may execute the application as needed. In this way, CPU11 is made executable by S150 without erasing the new application. When CPU11 activates the new application, it advances the process to S160.

In S160, CPU11 stores a plurality of pieces of required data in the storage 13. One of the plurality of requirements is the full usage of the new application calculated in S130. When CPU11 stores the largest usage of the new application in the storage 13, the following is performed. That is, CPU11 adds the maximum usage of the new application in association with the new application in the usage list. One of the plurality of necessary information is the priority level of the new application. Assuming that CPU11 stores the priority level in the storage 13, the storage 13 stores the priority level list. The priority list is a list in which a second data set in which one application and a priority level corresponding to the application are associated with each other is arranged by all existing applications. In other words, the priority list describes the priority level for each existing application for each of all existing applications. For example, in the priority list, an existing application is represented by an application identification value. The priority list currently stored in the storage 13 is obtained by adding the second data set every time a new application is added to the initial data of the priority list. The initial data of the priority list is stored in the storage 13 at the time of factory shipment of the vehicle 100. When CPU11 stores the priority-level of the new application in the storage 13, the following is performed. In other words, CPU11 reads out the priorities attached to the new application. Then, CPU11 adds the priority level of the new application to the priority level list in association with the new application. When CPU11 stores the maximum usage amount and the priority level of the new application in the storage 13, the series of processes of the addition process ends. When CPU11 finishes the additional processing through the processing of S150 and S160, the new application becomes one of the existing applications.

### Stop Process

CPU11 can execute a stopping process. As described above, CPU11 appropriately executes the existing applications stored in the storage 13 as needed. The stop process is a process for stopping the application being executed in relation to the usage of RAM15 or the charging rate SOC of the auxiliary battery 63. CPU11 executes a stopping process when a predetermined requirement is satisfied. The requirement may be that CPU11 concurrently execute a plurality of applications with differing priorities. While this requirement is satisfied, CPU11 repeats the stopping process described below.

On the assumption that the stopping process is performed, CPU11 repeatedly acquires the total usage of RAM15 at the respective timings by the plurality of running applications when the requirement is satisfied.

Further, CPU11 repeatedly calculates the charging rate SOC of the auxiliary battery 63 on the assumption that the stopping process is performed. CPU11 calculating the charging rate SOC of the auxiliary battery 63 corresponds to CPU11 acquiring the charging rate SOC of the auxiliary battery 63. The charging rate SOC of the auxiliary battery 63 is obtained by dividing the remaining capacity of the auxiliary battery 63 by the full charge capacity of the auxiliary battery 63. The full charge capacity of the auxiliary battery 63 is the maximum amount of electric power that the auxiliary battery 63 can store. For example, CPU11 calculates the full charge capacity of the auxiliary battery 63 based on the temperature/voltage of the auxiliary battery 63. CPU11 calculates the remaining capacity of the auxiliary battery 63 based on, for example, the voltage and current of the auxiliary battery 63. CPU11 repeatedly calculates the charging rate of the drive battery 61 in the same manner as the calculation of the charging rate SOC of the auxiliary battery 63. That is, CPU11 calculates the charging rate of the drive battery 61 based on the temperature/voltage and the current of the drive battery 61.

As illustrated in FIG. 3, when the stopping process is started, CPU11 first performs S200 process. In S200, CPU11 determines whether the total usage of the current RAM15 is greater than the usable amount. CPU11 proceeds to S220 if the total usage is greater than the usable amount (S200: YES). The details of S220 process will be described later.

On the other hand, when the total usage amount is equal to or less than the usable amount (S200: NO), CPU11 advances the process to S210. Then, CPU11 determines whether or not the charging rate SOC of the auxiliary battery 63 is equal to or less than a predetermined value in S210. The predetermined value will be described. For example, when the charging rate of the drive battery 61 decreases, CPU11 controls the power supply system to extend the cruising range of the vehicle 100 by supplying power from the auxiliary battery 63 to the drive battery 61. In this connection, the predetermined value is predetermined as the following value. In other words, the predetermined value is determined by experimentation or the like as a charging rate SOC that requires initiation of a treatment for reducing the electric power supplied to the accessories in order to secure a certain range of cruising ability. The storage 13 stores predetermined values in advance. In S210, when the charging rate SOC of the auxiliary battery 63 is larger than the predetermined value (S210: NO), CPU11 ends the series of processes of the stopping process. CPU11 then performs S200 process again, provided that the requirements are met.

On the other hand, when the charging rate SOC of the auxiliary battery 63 is equal to or less than the predetermined value (S210: YES), CPU11 advances the process to S220. In S220, CPU11 refers to the priority list to identify an application having the lowest priority level among a plurality of running applications. For example, if a plurality of running applications include a level 1 application, CPU11 identifies a level 1 application. For example, if a plurality of running applications do not include a level 1 application, CPU11 identifies a level 2 application. CPU11 identifies all the applications having the lowest priorities among the plurality of applications being executed. When CPU11 identifies the application with the lowest prioritization level, it suspends the execution of all the identified applications. After that, CPU11 ends the series of processes of the stopping process. Then, CPU11 executes S200 process again on condition that the necessary condition is satisfied.

### Operations of Embodiment

In the additional process, CPU11 knows the maximal usage of RAM15 used by the new application prior to enabling the new application (S130). Then, CPU11 determines whether to activate the new application (S140, S150, S170).

### Effects of Embodiment

(1) As described in the operation of the above embodiment, CPU11 of the present embodiment validates the new application after confirming the maximal usage of the new application in advance. With such a configuration, when CPU11 executes the application after the activation, for example, the storage area of RAM15 is tightened, and the execution of the respective applications can be prevented from being hindered.
(2) In the addition process, CPU11 executes a new application while the execution of the existing application is stopped, and calculates the maximal usage of the new application. The advantages of this will be explained. Here, when calculating the maximum usage of a new application, it is assumed that CPU11 has executed a new application while continuing to execute a pre-existing application. In this situation, CPU11 is likely to execute a plurality of applications in parallel. If the usage of RAM15 by these concurrently executing applications increases, the storage area of RAM15 may be tightened. In addition, RAM15 may not be able to store the generated data associated with the running of the application. In this case, execution of an existing application may be hindered.

In this regard, CPU11 according to the present embodiment executes a new application while stopping the execution of an existing application when calculating the maximal usage of the new application. Therefore, the processing related to the execution of the existing application is not affected.
(3) When CPU11 of the present embodiment activates a new application, it adds the full usage of the application to the usage listing. In this way, the usage list is updated every time a new application is activated. As a result, CPU11 can always grasp the maximum usage amount of each of the applications currently stored in the storage 13, and thus the maximum total usage amount that is the total of the applications. Here, in the present embodiment, in order to obtain the effect (2) described above, when calculating the maximum usage amount of a new application, execution of all existing applications is stopped. Even in a situation where the execution of all the pre-existing applications is stopped, CPU11 can reliably grasp the maximal total usage in the configuration of the present embodiment. When the maximum total usage amount can be grasped, a value obtained by subtracting the maximum total usage amount from the usable amount can be set as the setting value. When the maximum usage amount of the new application is equal to or less than this set value, after the new application is activated, a situation may occur in which all the applications stored in the storage 13 are executed in parallel. Even in such cases, the total usage of RAM15 associated with executing all these applications will be less than or equal to the usable usage. Therefore, CPU11 can execute all the applications in parallel without pushing the storage area of RAM15.
(4) The usage of RAM15 associated with running an application may, for some reason, exceed the pre-determined maximal usage. In this context, the following may occur: That is, when CPU11 executes a plurality of applications in parallel, the total usage of RAM15 may exceed the usable amount. If CPU11 continues to execute a plurality of applications in this circumstance, the execution of the respective applications may be hindered.

In this regard, in CPU11 of the present embodiment, when the total usage amount of RAM15 associated with the execution of the plurality of applications exceeds the usable amount, the execution of the lowest-priority application is stopped. Therefore, even in the above-described situation, CPU11 can secure a RAM15 storage area in which a higher-priority application can be used. Therefore, the configuration of the present embodiment does not hinder the execution of an application having a high priority.
(5) A situation may arise in which the charging rate SOC of the auxiliary battery 63 is reduced while the vehicle 100 is in use. If CPU11 continues to execute a plurality of applications in this circumstance, the cruising range may be affected.

In this regard, in CPU11 of the present embodiment, when the charging rate SOC of the auxiliary battery 63 falls below a predetermined value, the lowest-priority application among the running applications is stopped. Therefore, CPU11 can continue to execute high-priority applications while securing the range of cruising in an emergency.

### Modifications

The above embodiment can be implemented with the following modifications. The above embodiments and the following modifications can be combined with each other within a technically consistent range to be implemented.
With regard to S220 process of the stop process, if a plurality of applications having the lowest priorities exist among the plurality of applications being executed, it is not essential to stop the execution of all of these applications. CPU11 may stop one or more applications having the lowest priorities among the plurality of running applications.
It can be said that the drive battery 61 supplies electric power to the information processing device 10 via the auxiliary battery 63. In S210 of the stopping process, the charging rate of the drive battery 61 may be compared with a predetermined value. In this case, the predetermined value may be set to an appropriate value for the drive battery 61. That is, the method of determining the predetermined value is not limited to the example of the above-described embodiment. In S210, the determination may be made considering both the charging rate SOC of the auxiliary battery 63 and the charging rate of the drive battery 61.
It is not essential to determine whether to stop the execution of the application in accordance with the amount of the charging rate of the battery.
It is not essential to determine that an application is to be stopped depending on the total usage of RAM15 by a plurality of applications.
In determining to stop the execution of the application, the following aspects may be adopted. Suppose that, while an application is running, RAM15 usage by the application exceeds the maximal usage seen during testing. At this time, the execution of the application may be stopped. That is, for each application, the execution stop may be determined in relation to the maximum usage amount of the application.
The number of priority levels is not limited to the example of the above-described embodiment. The required number of priority levels may be set as appropriate.
It is not essential to define a priority level.
The setting value is not limited to the example of the above-described embodiment. For example, a storage capacity to be allocated to each application in the storage 13 may be determined in advance, and such a value may be set as a setting value.
In a case where the mode of the above-described modification example is adopted as the setting value, the maximum usage amount of the new application in the addition processing may not be stored in the storage 13.
When calculating the maximum usage of a new application in the addition process, it is not essential to stop the execution of all existing applications. The execution of the existing application may be stopped only for some existing applications, or the execution of the existing application may not be considered at all.
The activation mode is not limited to the example of the above-described embodiment. For example, an approval area, which is a dedicated storage area for storing an application approved to be added to the storage 13, is provided in advance in the storage 13. When a new application is downloaded by S100, the downloaded new application is stored in a storage area other than the approval area in the storage 13. Then, in S150, a new application stored in a storage area other than the approval area by S100 is moved to the approval area. In this way, it may be enabled to transfer a new application to a dedicated storage area. In addition, for example, an approval list in which applications approved to be added to the storage 13 are listed is prepared in advance. Then, it may be enabled to add the application identification value of the new application to the approval list. Enabling allows new applications to be enabled without erasing them from storage 13.
As described in the above embodiments, S170 process may not completely erase new applications. In this case, the following is possible. For example, it is assumed that the free space of the storage 13 is increased by erasing an application different from the new application stored in the storage 13. Then, it is assumed that the addition of the new application that has been temporarily sent to the storage 13 is requested again. At this time, if the storage 13 still stores the new application, it is not necessary to download the new application in S100 when the additional process is performed again. That is, the process of S100 can be skipped and the process can be started from S110.
Vehicles to which the information processing device 10 is applied are not limited to battery electric vehicle. For example, the vehicle to which the information processing device 10 is applied may be a hybrid electric vehicle or an engine-driven vehicle.

What is claimed is:

1. A vehicle information processing device comprising:
an execution unit;
a first storage unit that stores an application that is executable by the execution unit; and
a second storage unit that temporarily stores data generated by the execution unit executing the application, wherein
the execution unit is configured to:
when a request to store a new application in the first storage unit is received, download the new application and store the new application in the first storage unit;
calculate a maximum usage amount of the second storage unit to be used in conjunction with execution of the new application; and
erase the new application from the first storage unit when the calculated maximum usage amount is more than a set value determined in advance, and render the new application executable without erasing the new application from the first storage unit when the calculated maximum usage amount is equal to or less than the set value.

2. The vehicle information processing device according to claim 1, wherein when applications stored in the first storage unit when the execution unit receives the request are defined as existing applications,
the execution unit executes the new application and monitors a usage amount of the second storage unit during execution of the new application, with execution of all the existing applications stopped, when calculating the maximum usage amount for the new application.

3. The vehicle information processing device according to claim 2, wherein:
the first storage unit stores, for each of the existing applications, the maximum usage amount of the second storage unit to be used in conjunction with execution of the existing application;
when a usage amount of the second storage unit to be used in conjunction with concurrent execution of all the existing applications is defined as a maximum total usage amount, the set value is determined as a value obtained by subtracting the maximum total usage amount from a usable amount determined in advance; and
the execution unit stores the maximum usage amount for the new application in the first storage unit in correlation with the new application when the new application is rendered executable without erasing the new application from the first storage unit.

4. The vehicle information processing device according to claim 3, wherein:
when a level that indicates a priority of continuing execution of an application when the execution unit executes the application is defined as a priority level,
the first storage unit stores the priority level for each of the existing applications;
the execution unit stores the priority level for the new application in the first storage unit in correlation with the new application when the new application is rendered executable without erasing the new application from the first storage unit; and
the execution unit is further configured to
when a plurality of applications with different priority levels are executed concurrently, acquire a total usage amount of the second storage unit for a plurality of applications being executed, and
when the total usage amount is larger than the usable amount, stop execution of one or more applications with a lowest priority level, among the applications being executed.

5. The vehicle information processing device according to claim 1, wherein:
when a level that indicates a priority of continuing execution of an application when the execution unit executes the application is defined as a priority level, and when applications stored in the first storage unit when the execution unit receives the request are defined as existing applications,
the first storage unit stores the priority level for each of the existing applications;
the execution unit stores the priority level for the new application in the first storage unit in correlation with the new application when the new application is rendered executable without erasing the new application from the first storage unit; and
the execution unit is further configured to
acquire a charging rate of a battery that supplies electric power to the vehicle information processing device, and
when a plurality of applications with different priority levels are executed concurrently, stop execution of one or more applications with a lowest priority level, among the applications being executed, when the charging rate of the battery is equal to or less than a predetermined value determined in advance.
